(19) United States
(12) Patent Application Publication
(10) Pub. No.: US 2015/0112879 A1
(43) Pub. Date: Apr. 23, 2015

(54) SYSTEMS AND METHODS FOR EVALUATING PRICING OF REAL ESTATE

(71) Applicant: MasterCard International Incorporated, Purchase, NY (US)

(72) Inventors: Debashis Ghosh, Charlotte, NC (US); Randy Shuken, Westport, CT (US)

(73) Assignee: MasterCard International Incorporated, Purchase, NY (US)

(21) Appl. No.: 14/060,844

(22) Filed: Oct. 23, 2013

(51) Int. Cl. G06Q 50/16; G06Q 10/10

(52) U.S. Cl. CPC G06Q 50/16; G06Q 10/10
USPC 705/313

(57) ABSTRACT

A computer-implemented method for evaluating pricing of real estate is implemented by a computing device coupled to a memory. The method includes storing within the memory a plurality of rental data sets wherein each rental data set is associated with a geographic region and wherein each rental data set includes actual rental payment amounts made by tenants using a payment card, receiving a rental data request associated with at least one real estate asset having a physical location, from a requestor, retrieving at least one of the rental data sets associated with a geographic region containing the physical location of the at least one real estate asset, processing the rental data set into a financial assessment associated with the at least one real estate asset, and transmitting the financial assessment to the requestor.

### BACKGROUND OF THE DISCLOSURE

The field of the disclosure relates generally to real estate pricing, and more particularly, to systems and methods for evaluating pricing of real estate.

At least some known systems used for pricing real estate attempt to determine real estate prices based, in part, on the rental income associated with a unit or units included on the real estate. In at least the case of rental properties, real estate pricing depends in part on the rental income associated with the real estate. Some known systems may use a listed rental price to evaluate the price of rental real estate. However, there is oftentimes a variance between a listed rental price and an actual rental price (i.e., the rental price actually paid by the tenant to the landlord). Accordingly, these known systems fail to provide accurate estimates for rental real estate.

In order for prospective landlords (e.g., buying real estate) to determine a cash flow and a price for the real estate, the actual rental data of nearby similar/comparable properties may be useful. Additionally, the actual rental data may be used in conjunction with other data, including property tax data, square footage, and floor plans, to determine a value for a real estate property. In order for prospective tenants (e.g., renting real estate) to determine rental prices, it would be helpful to be able to determine the actual rental data of nearby similar/comparable properties. Accordingly, a system for determining a price associated with a rental property based, at least in part, on actual rental data is needed.

### BRIEF DESCRIPTION OF THE DISCLOSURE

In one aspect, a computer-implemented method for evaluating pricing of real estate is provided. The method is implemented by a computing device coupled to a memory. The method includes storing within the memory a plurality of rental data sets wherein each rental data set is associated with a geographic region and wherein each rental data set includes actual rental payment amounts made by tenants using a payment card, receiving a rental data request associated with at least one real estate asset having a physical location, from a requestor, retrieving at least one of the rental data sets associated with a geographic region containing the physical location of the at least one real estate asset, processing the rental data set into a financial assessment associated with the at least one real estate asset, and transmitting the financial assessment to the requestor.

In another aspect, a pricing computer system for evaluating pricing of real estate is provided. The pricing computer system includes a processor and a memory coupled to the processor. The pricing computer system is configured to store within the memory a plurality of rental data sets wherein each rental data set is associated with a geographic region and wherein each rental data set includes actual rental payment amounts made by tenants using a payment card, receive a rental data request associated with at least one real estate asset having a physical location from a requestor, retrieve from the memory at least one of the rental data sets associated with a geographic region containing the physical location of the at least one real estate asset, process the rental data set into a financial assessment associated with the at least one real estate asset, and transmit the financial assessment to the requestor.

In a further aspect, computer-readable storage media for evaluating pricing of real estate is provided. The computer-readable storage media has computer-executable instructions embodied thereon. When executed by at least one processor, the computer-executable instructions cause the processor to store a plurality of rental data sets wherein each rental data set is associated with a geographic region and wherein each rental data set includes actual rental payment amounts made by tenants using a payment card, receive a rental data request associated with at least one real estate asset having a physical location, from a requestor, retrieve at least one of the rental data sets associated with a geographic region containing the physical location of the at least one real estate asset, process the rental data set into a financial assessment associated with the at least one real estate asset, and transmit the financial assessment to the requestor.

### BRIEF DESCRIPTION OF THE DRAWINGS

The figures listed below show example embodiments of the methods and systems described herein.

FIGS. 1-8 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example pricing computer system used to evaluate the pricing of real estate including a plurality of computer devices in accordance with one example embodiment of the present disclosure.

FIG. 3 is an expanded block diagram of an example embodiment of a server architecture of the pricing computer system used to evaluate the pricing of real estate including the plurality of computer devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a simplified block diagram of an example embodiment of a system for storing a plurality of rental data sets received in payment card transactions.

FIG. 7 is a simplified block diagram of an example embodiment of a system for generating and transmitting a financial assessment to a requestor in response to a rental data request.

FIG. 8 is a simplified diagram of an example method of evaluating pricing of real estate using the pricing computer system of FIG. 2.

FIG. 9 is a diagram of components of one or more example computing devices that may be used in the environment shown in FIGS. 6 and 7.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

This subject matter described herein relates generally to evaluating prices of real estate. Rental data requests associated with a physical location are received from a requestor. Specifically, the methods and systems described herein include storing a plurality of rental data sets wherein each rental data set is associated with a geographic region and wherein each rental data set includes actual rental payment amounts made by tenants using a payment card, receiving from a requestor a rental data request associated with at least one real estate asset having a physical location, retrieving at least one of the rental data sets associated with a geographic region containing the physical location of the at least one real estate asset, processing the rental data set into a financial assessment associated with the at least one real estate asset, and transmitting the financial assessment to the requestor.

In some real estate pricing evaluation systems, listed rental prices may be used to evaluate the price of rental real estate. Listed rental prices are used as a proxy for actual rental income and thereby used to determine cash flow for the rental property. Upon appropriate cash flow discounting and processing, such real estate pricing evaluation systems determine a valuation for the rental property. In many known cases, a discrepancy may exist between the listed rental prices and the actual rental prices. Therefore, the listed rental prices may not be a reliable source upon which to determine a valuation. Further, rental properties may have a variety of gaps in time between the departure of a first tenant and the tenancy of a second tenant. Such gaps are not reflected in listed rental prices alone but may further impact the cash flow of the real estate and accordingly affect the valuation of the real estate.

The systems and methods described herein are configured to evaluate real estate pricing. A real estate price evaluation computer system (“pricing computer system”) receives a plurality of rental data sets. The pricing computer system is in communication with at least one of a merchant bank computer system, an issuer bank computer system, a payment network, and a payment network computer system (collectively referred to as “payment systems”). The pricing computer system receives the plurality of rental data sets by first receiving transaction data from at least one of the merchant bank computer system, issuer bank computer system, payment network, and payment network computer system. The pricing computer system determines that the transaction data is associated with a rental transaction based upon the presence of a rental transaction indicator. As described below, the pricing computer system determines the presence of a rental transaction indicator by scanning the transaction data for the presence of at least one rental transaction indicator. The rental transaction indicator may include any characteristic which can identify a transaction as a rental transaction. Accordingly, as described below, the rental transaction indicator may represent a rental payee where a rental payee represents a payee of the transaction known to be a real estate merchant (e.g., a landlord or a property management service.) Alternately, the rental transaction indicator may represent the detection of a fixed, periodic payment with certain numeric characteristics. For example, if a payor has a recurring, fixed transaction on or near the same approximate day of the month, the transactions may be identified as rental transactions. Upon determining that the transaction data is associated with a rental transaction, the pricing computer system processes the transaction data into rental data. Rental data represents a data set associated with at least one payor for a particular real estate. Rental data may include, for example and without limitation, geographic region of the real estate, a rental price, a move-in date to the real estate, a move-out date from the real estate, a record of increases in rental prices, and a categorization of the real estate. The categorization of the real estate may include any categorization of real estate including, for example, apartments, single family houses, multi-family houses, duplexes, and quadplexes.

Rental data is additionally segmented into a plurality of real estate assets. In other words, the pricing computer system determines from the plurality of rental data, a plurality of real estate assets. The pricing computer system further determines a real estate identifier associated with each of the real estate assets. The real estate identifier may include, for example, a street address, a geographic coordinate identifier, and an alphanumeric listing which identifies a property within a real estate service including, for example, a multiple listing service (“MLS”). The real estate identifier is used to retrieve real estate inventory data associated with each real estate asset. The real estate inventory data may be retrieved from an external service, a memory device, or a database such as a real estate inventory database. The retrieved real estate inventory data is stored by the pricing computer system such that the real estate inventory data may be accessed with or referenced by the rental data. The real estate inventory data may include, for example and without limitation, property tax data associated with the real estate asset, a square footage associated with the real estate asset, a physical layout or floor-plan associated with the real estate asset, historical maintenance and servicing records associated with the real estate asset, and the total number of rentable units associated with the real estate asset.

The pricing computer system may further apply the real estate inventory data to the rental data to determine an economic value associated with the real estate asset. An economic value may be, for example, an appraisal value of a real estate asset, a recommended bidding price for a real estate asset, a projected profitability for a real estate asset, or any other economic value that may be used by a prospective purchaser, lessor, financier, insurer, or any other financially interested party. For example, the real estate inventory data may indicate the number of units (e.g., apartment units) in a real estate asset, the location of a real estate asset, and the maintenance and history of the real estate asset. Such information may facilitate a more accurate analysis of the economic value of the real estate asset than an analysis relying upon cash flow alone. For example, certain properties may have more positive or negative multipliers depending upon their maintenance and history. An apartment complex which is newly refurbished may preserve its cash flow better going forwards and not face repairs imminently while an apartment complex in relative disrepair may have an economic value which is less than otherwise indicated by a cash flow analysis based upon recent rental data.

In the example embodiment, rental data sets are stored without including protected personal information, also known as personally identifiable information. Personally identifiable information may include any information capable of identifying an individual including a tenant or a landlord. For privacy and security reasons, personally identifiable information may be withheld from the rental data sets. In some examples where privacy and security can otherwise be ensured, personally identifiable information may be retained in the rental data sets. In such examples, personally identifiable information may be needed to create enhanced financial assessments.

In situations in which the systems discussed herein collect personal information about individuals including cardholders or merchants, or may make use of such personal information, the individuals may be provided with an opportunity to control whether such information is collected, or to control whether and/or how such information is used. In addition, certain data may be treated in one or more ways before it is stored or used, so that personally identifiable information is removed. For example, an individual's identity may be treated so that no personally identifiable information can be determined for the individual, or an individual's geographic location may be generalized where location data is obtained (such as to a city, ZIP code, or state level), so that a particular location of an individual cannot be determined Thus, the individual may have control over how information is collected about the individual and used by systems including the pricing computer system.

By storing the rental data sets, the pricing computer system is able to substantially create a rental data database. The rental data database includes a variety of rental data. In other words, the rental data database includes data associated with a variety of real estate properties over a period of time and a range of geographic locations. The rental data database may be stored at the pricing computer system or alternately be in communication, such as networked communication, with the pricing computer system. The rental data database may be used for a variety of purposes including evaluating specific real estate properties, categories of real estate, and real estate behavioral patterns. In the example embodiment, the rental data database is used to determine financial assessments related to the real estate. The pricing computer system may also receive further data which is integrated into the rental data database. In the example embodiment, the pricing computer system receives a plurality of rental listing data associated with a geographic region. The pricing computer system stores the plurality of rental listing data. In some examples, the pricing computer system may associate the rental listing data with the rental data sets. Accordingly, in such embodiments, the pricing computer system can access real estate data including actual rental data and rental listing data. The pricing computer system can determine differentials between actual rental data and rental listing data and identify, for example, mispricing of real estate assets.

The pricing computer system receives a rental data request associated with at least one real estate asset with a physical location from the requestor. In other words, a requestor uses a requestor computer system to submit a query to the pricing computer system regarding financial characteristics of at least one real estate property. In alternative embodiments, the requestor may query regarding a geographic region containing real estate properties. The pricing computer system retrieves at least one of the rental data sets associated with a geographic region containing the location of the at least one real estate asset. Further, the pricing computer system may retrieve data associated with the at least one of the rental data sets including, for example, real estate inventory data and rental listing data. The pricing computer system processes the rental data set and other retrieved data into a financial assessment associated with the at least one real estate asset. The financial assessment may include, for example, and without limitation, a projected rental listing price for the real estate asset, a projected rental sales price for the real estate asset, a projected cash flow for the real estate asset, a projected value for the real estate asset, and a variance between the projected rental listing price and the projected rental sales price for the real estate asset. The pricing computer system transmits the financial assessment to the requestor. Transmission of the financial assessment may include any appropriate communication medium including, without limitation, email, web service, web publication, SMS messaging, file transfer, facsimile, and transmission of a physical financial assessment.

Described in detail herein are example embodiments of systems and methods for evaluating pricing of real estate. The systems and methods facilitate, for example, storing a plurality of rental data sets wherein each rental data set is associated with a geographic region and wherein each rental data set includes actual rental payment amounts made by tenants using a payment card, receiving a rental data request associated with at least one real estate asset having a physical location from a requestor, retrieving at least one of the rental data sets associated with a geographic region containing the physical location of the at least one real estate asset, processing the rental data set into a financial assessment associated with the at least one real estate asset, and transmitting the financial assessment to the requestor. A technical effect of the systems and methods described herein include at least one of (a) improving the quality of real estate pricing evaluation; (b) providing real estate renters and landlords with accurate rental rates for a particular geographic location, real estate category, or a particular real estate asset; (c) improving the cash flow analysis available to prospective and actual landlords; and (d) identifying variances between rental listing prices and projected rental sales prices to facilitate more accurate pricing.

More specifically, the technical effects can be achieved by performing at least one of the following steps: (a) storing a plurality of rental data sets, wherein each rental data set is associated with a geographic region and wherein each rental data set includes actual rental payment amounts made by tenants using a payment card; (b) receiving a rental data request associated with at least one real estate asset having a physical location, from a requestor; (c) retrieving at least one of the rental data sets associated with a geographic region containing the physical location of the at least one real estate asset; (d) processing the rental data set into a financial assessment associated with the at least one real estate asset; (e) transmitting the financial assessment to the requestor; (f) receiving transaction data associated with a financial transaction from a payment system; (g) determining that the transaction data is associated with a rental transaction based upon the presence of a rental transaction indicator; (h) processing the transaction data into rental data, wherein rental data includes at least one of a geographic region, a rental price, a move-in date, a rental increase history, and a property categorization; (i) scanning the transaction data for the presence of at least one rental transaction indicator wherein the rental transaction indicator includes at least one of a rental payee, a payment period, numerical characteristics of a payment, and a repeated payment amount; (j) receiving, at the computing device, a plurality of rental listing data associated with a geographic region; (k) storing the plurality of rental listing data; (l) storing the plurality of rental data sets associated with a category of real estate; (m) storing the plurality of rental data sets without including personally identifiable information; (n) processing the rental data set into a financial assessment associated with the at least one real estate asset wherein the financial assessment is at least one of a projected rental listing price for the real estate asset, a projected rental sales price for the real estate asset, a projected cash flow for the real estate asset, a projected value for the real estate asset, and a variance between the projected rental listing price and the projected rental sales price for the real estate asset; (o) determining from the plurality of rental data a plurality of real estate assets; (p) determining from the plurality of real estate assets, a plurality of identifiers associated with the plurality of real estate assets; (q) retrieving real estate inventory data associated with each of the plurality of identifiers associated with the plurality of real estate assets; (r) storing the real estate inventory data; (s) determining, using the rental data and the real estate inventory data, at least one economic value associated with each of the plurality of real estate assets; and (t) retrieving real estate inventory data wherein the real estate inventory data includes at least one of property tax data associated with the real estate asset, square footage associated with the real estate asset, a physical layout associated with the real estate asset, and historical maintenance records associated with the real estate asset.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the evaluation of real estate pricing.

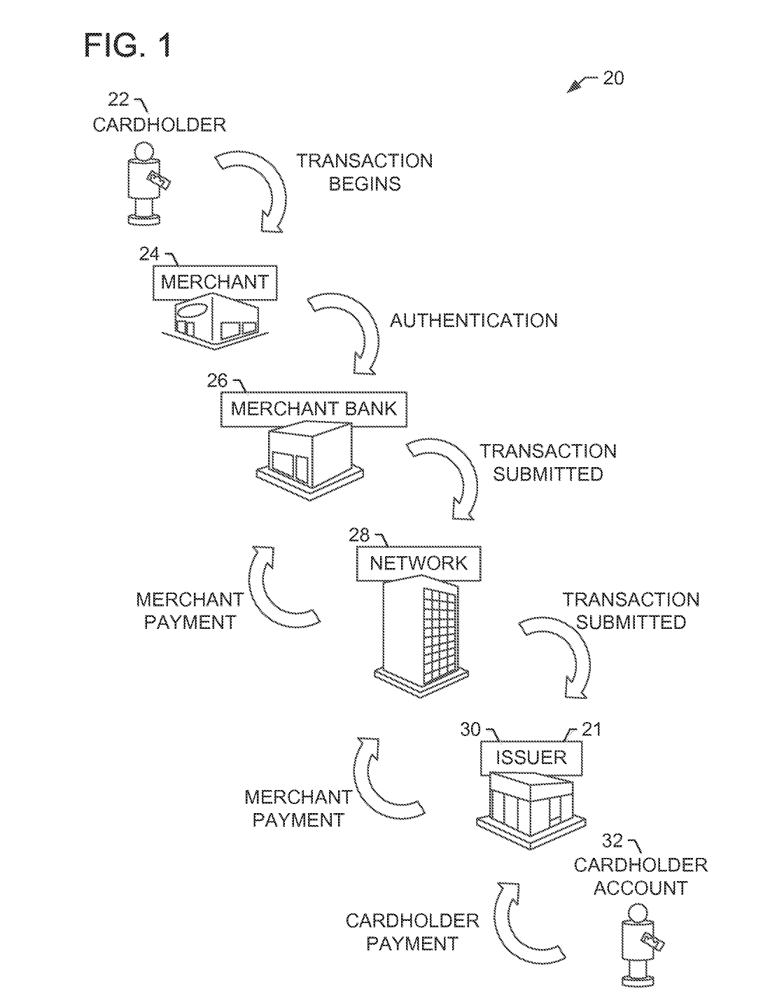

FIG. 1 is a schematic diagram illustrating an example multi-party transaction card industry system 20 for enabling ordinary payment-by-card transactions in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

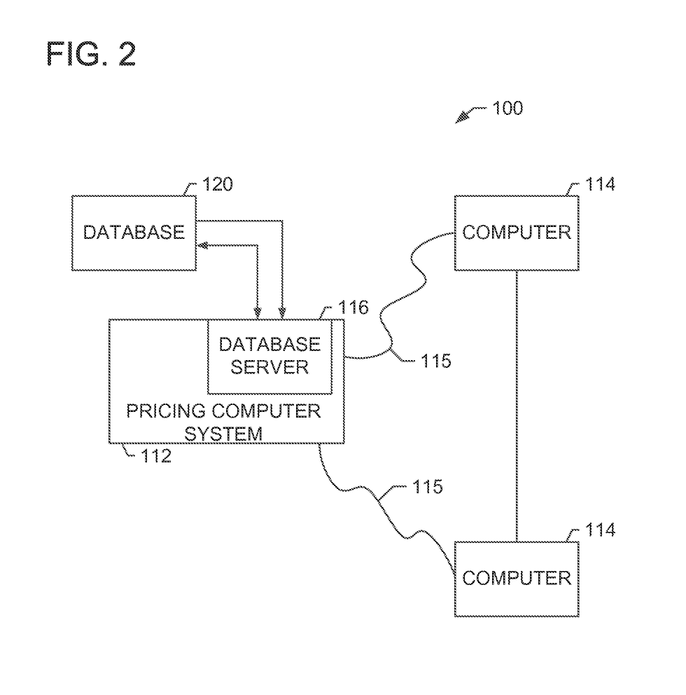

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, such additional data may also include data related to the rental of a real estate property including, for example, a geographic region of the real estate or the merchant (i.e., landlord or property management service), and a property categorization. In the example embodiment, when cardholder 22 makes a rental payment for a rental property, at least partial rental data is transmitted during the clearance process as transaction data. When interchange network 28 receives the rental data, interchange network 28 routes the rental data to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, a real estate price evaluation system may be used to determine financial assessments related to real estate assets based at least partially upon real estate data received in payment card transactions. Although the systems described herein are not intended to be limited to facilitate such applications, the systems are described as such for exemplary purposes.

FIG. 2 is a simplified block diagram of an example pricing computer system 100 used to evaluate the pricing of real estate including a plurality of computer devices connected in communication in accordance with the present disclosure. In the example embodiment, system 100 is used for storing rental data sets, receiving rental data requests, processing rental data sets into financial assessments, and transmitting such financial assessments to requestors, as described herein. In other embodiments, the applications may reside on other computing devices (not shown) communicatively coupled to system 100, and may perform real estate pricing evaluation using system 100.

More specifically, in the example embodiment, system 100 includes a pricing computer system 112, and a plurality of client sub-systems, also referred to as client systems 114, connected to pricing computer system 112. In one embodiment, client systems 114 are computers including a web browser, such that pricing computer system 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on pricing computer system 112 and can be accessed by potential users at one of client systems 114 by logging onto pricing computer system 112 through one of client systems 114. In an alternative embodiment, database 120 is stored remotely from pricing computer system 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with acquirer bank 26 (shown in FIG. 1) while another one of client systems 114 may be associated with issuer bank 30 (shown in FIG. 1). Pricing computer system 112 may be associated with interchange network 28. In the example embodiment, pricing computer system 112 is associated with a network interchange, such as interchange network 28, and may be referred to as an interchange computer system. Pricing computer system 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

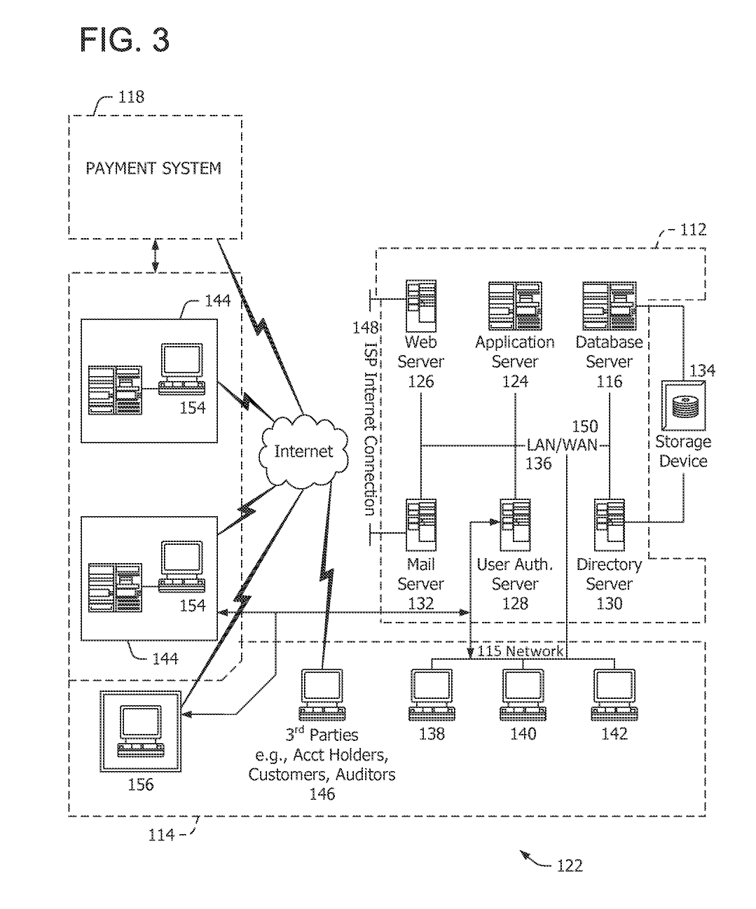

FIG. 3 is an expanded block diagram of an example embodiment of a computer server system architecture of a processing system 122 used to evaluate the pricing of real estate including other computer devices in accordance with one embodiment of the present disclosure. Components in system 122, identical to components of system 100 (shown in FIG. 2), are identified in FIG. 3 using the same reference numerals as used in FIG. 2. System 122 includes pricing computer system 112, client systems 114, and payment systems 118. Pricing computer system 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Pricing computer system 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Pricing computer system 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with pricing computer system 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with pricing computer system 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

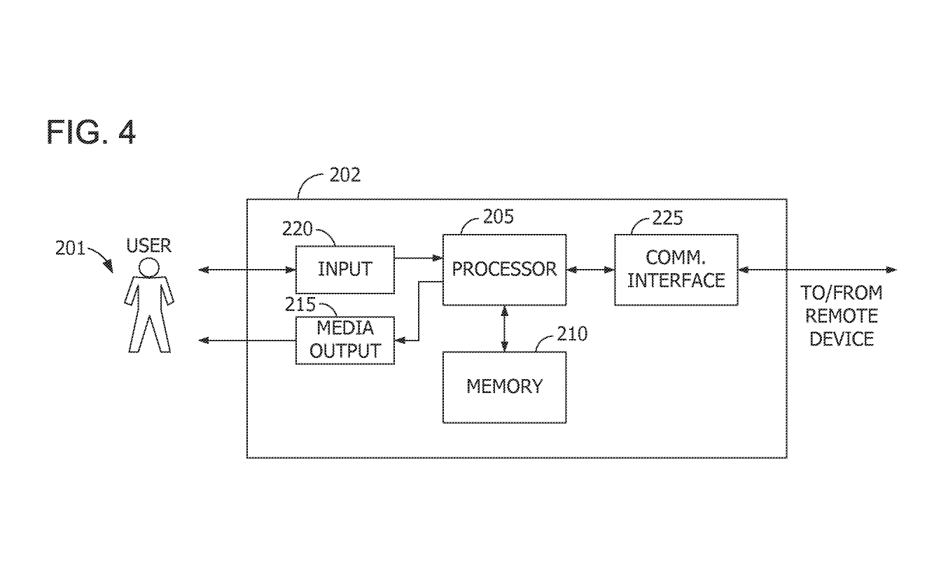

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as pricing computer system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from pricing computer system 112. A client application allows user 201 to interact with a server application from pricing computer system 112.

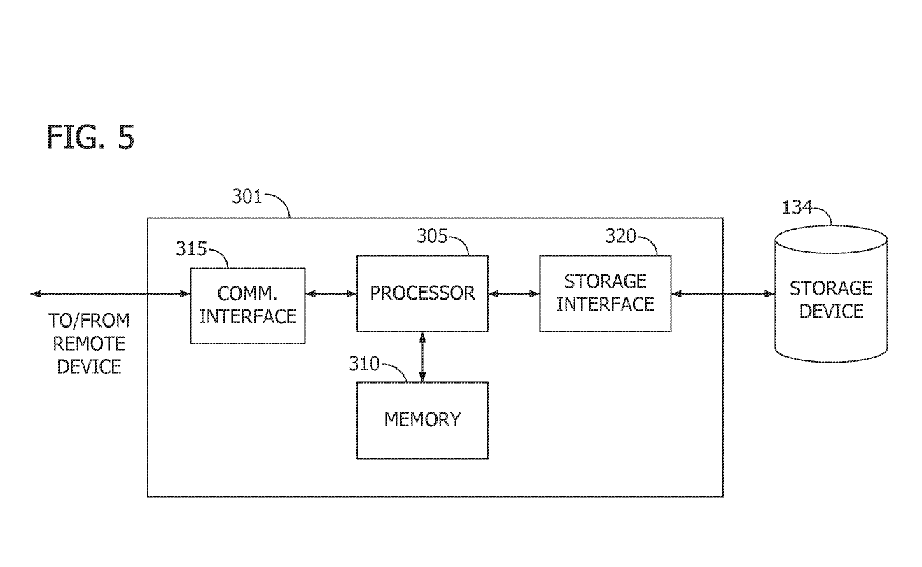

FIG. 5 illustrates an example configuration of a server system 301 such as pricing computer system 112 (shown in FIGS. 2 and 3). Server system 301 may include, but is not limited to, database server 116, transaction server 124, web server 126, user authentication server 128, directory server 130, and mail server 132. In the example embodiment, server system 301 performs evaluation of real estate pricing, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

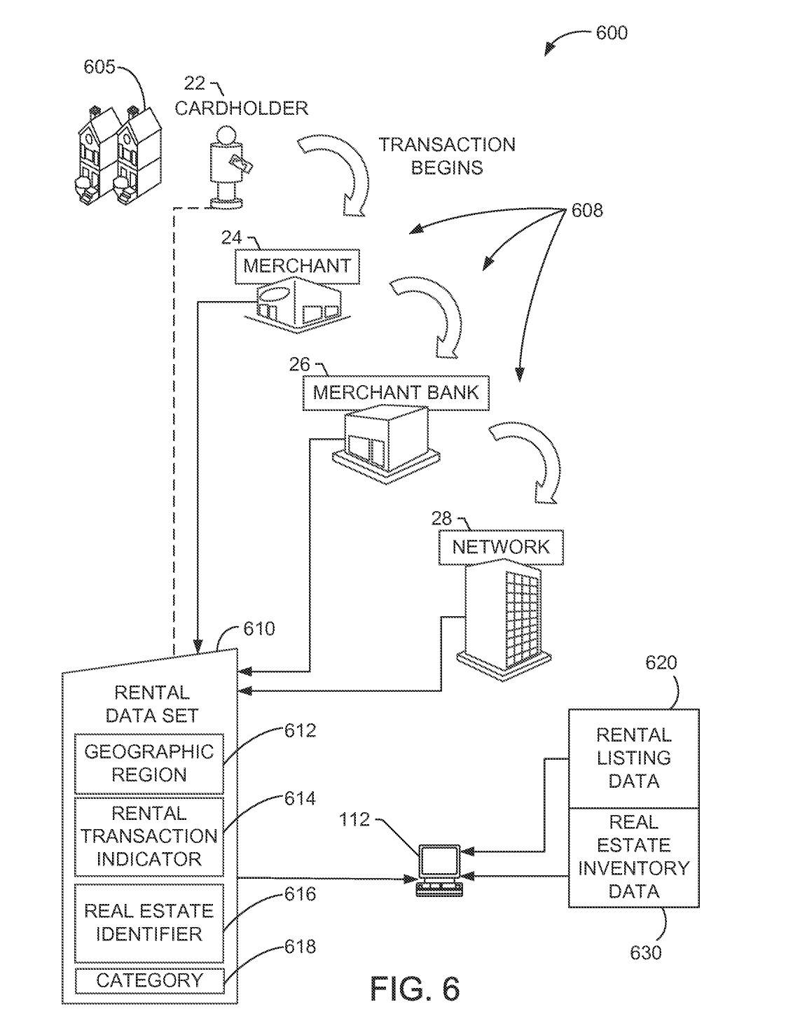

FIG. 6 is a simplified block diagram of an example embodiment of a system 600 for storing a plurality of rental data sets received through payment card transactions. As described in FIG. 1, cardholder 22 tenders payment for a purchase with a transaction card, merchant 24 requests authorization through merchant bank 26 for the amount of the purchase. In the example embodiment, cardholder 22 is a tenant occupying real estate 605 and making a rental payment for real estate 605. Also, in the example embodiment, real estate 605 represents a unit in an apartment complex in a geographic region. Alternately, real estate 605 may be any real estate which is rentable by cardholder 22. Accordingly, cardholder 22 tenders payment in the form of a rental payment to merchant 24, where merchant 24 is a landlord or a property management company. As described above, before or during the clearing process, additional transaction data related to the rental transaction is transferred among the parties to the transaction, such as merchant bank 26, interchange network 28, and issuer bank 30 (shown in FIG. 1). Such additional transaction data includes rental data set 610. In the example embodiment, rental data set 610 includes a geographic region 612. Geographic region 612 may be any geographic identifier including, for example and without limitation, a postal code, a city/town/municipality, a neighborhood in a city/town/municipality, GPS coordinates, a county, and sub-divisions of any of the preceding geographic identifiers. Pricing computer system 112 receives rental data set 610 from a payment system 608. Payment system 608 includes computer systems associated with merchant 24, merchant bank 26, interchange network 28, issuer bank 30 and interchange network 28. In the example embodiment, rental data set 610 may include as follows (Table 1):

TABLE 1

| Transaction | Transaction | Transaction | Geographic | |
|---|---|---|---|---|
| Date | Time | Amount | Location | Merchant |
| Jan. 1, | 12:15 PM | $550.00 | Anytown | Property |
| 2014 | | | | Management |
| | | | | Services ABC |

In the example embodiment, cardholder 22 is a tenant paying rent to landlord 24. However, pricing computer system 112 is configured to identify a particular transaction as a rental transaction to distinguish between received transaction data containing rental data sets 610 and transaction data that does not contain rental data sets 610. Accordingly, pricing computer system 112 is configured to identify a rental transaction indicator 614. Rental transaction indicator 614 represents an identifying flag for identifying a transaction as a rental transaction that contains rental data sets 610 and is stored at pricing computer system 112. As described herein, rental data sets 610 and associated data are stored any appropriate storage device available to pricing computer system 112. In the example embodiment, pricing computer system 112 stores rental data sets 610 and associated data (e.g., rental listing data 620 and real estate inventory data 630) at memory 310 (shown in FIG. 5). In alternative embodiments, pricing computer system 112 may store rental data sets 610 and associated data at storage device 134 (shown in FIG. 5) or any other appropriate storage device including a networked database in communication with pricing computer system 112 such as database 120 (shown in FIG. 2).

Rental transaction indicator 614 includes, for example and without limitation, a rental payee, a payment period, numerical characteristics of a payment, and a repeated payment amount. A particular payee (i.e., merchant 24) may be identified as a rental merchant 24. In one example, pricing computer system 112 may include a database of known merchants 24 renting real estate. In alternative examples, merchant 24 may be listed in transaction data with data such as words or phrases indicating that merchant 24 is a landlord including, for example, “Property Management”, “Property Services”, and “Landlord.” Payment period may also be a rental transaction indicator 614. If cardholder 22 makes a payment at or near the same date of the month for several months in succession and for a recurring amount, the transactions associated with such periodic payments may be noted as having rental transaction indicators 614 and may be identified as containing rental data sets 610. However, at least some additional transactions may be periodic and for a recurring amount but not be associated with rental transactions. For example, car payments may be paid at the same date every month. Car payments may be distinguished by the fact that the car payments lack numerical characteristics typical of real estate transactions. For example, rental transactions tend to be in round numbers (e.g. $500 per month) while car payments tend to have non-round numbers. To further illustrate the determination of rental transaction indicator 614 data below indicates both rental transactions and non-rental transactions (Table 2):

TABLE 2

| Transaction | Transaction | Transaction | Geographic | |
|---|---|---|---|---|
| Date | Time | Amount | Location | Merchant |
| Jan. 1, | 12:15 PM | $550.00 | Anytown | [symbol] |
| 2014 | | | | [symbol] |
| | | | | [symbol] |
| | | | | [symbol] |
| Jan. 9, | 2:44 PM | $25.35 | Anytown | ABC Gas-N- |
| 2014 | | | | Go |
| [symbol] | 1:26 PM | [symbol] | Anytown | [symbol] |
| [symbol] | | | | [symbol] |
| | | | | [symbol] |
| | | | | [symbol] |
| Feb. 2, | 1:33 AM | $107.24 | Anytown | Molly's |
| 2014 | | | | Restaurant |
| [symbol] | 3:26 PM | [symbol] | Anytown | [symbol] |
| [symbol] | | | | [symbol] |
| | | | | [symbol] |
| | | | | [symbol] |

Rental transaction indicators 614 are shown in Table 2 in bold and italics. Note that in Table 2, rental transaction indicators 614 are indicated based on payment period (rental payments are always made on the first of the month), numerical characteristics (rental payments are always for $550.00), and merchant identifiers (rental payments are made to “Property Management Services ABC.). In at least some cases, rental data sets 610 may deviate from some of these characteristics. Accordingly, pricing computer system 112 processes such deviating rental data sets 610 accordingly. For example, cardholder 22 may move out of real estate 605 in the middle of the month and only pay a partial payment for that month. Further in the last month of payment, cardholder 22 may receive a refund based on a security deposit refund. Pricing computer system 112 may review the plurality of rental data sets 610 and determine that the last month is an outlier due to the payment being on a different date than normal, and being a different amount than normal. Further, after the final month, pricing computer system 112 may process rental data sets 610 and determine that no new rental data sets 610 have arrived. Accordingly, rental data set 610 for the last month may not be used to determine a financial assessment associated with real estate 605, as discussed below. However, rental data set 610 for the last month may be retained for other analysis and flagged as a, “move-out date.” Alternately, the last month may be removed from rental data set 610 because it represents an outlier.

In a second example, a first month's payment by cardholder 22 may be higher than normal due to security deposit payments. Similarly, as pricing computer system 112 receives recurring rental data sets 610 which deviate from the first month's payment, rental data set 610 for the first month may be retained for other analysis and flagged as a, “move-in date.” Alternately, pricing computer system 112 may remove rental data set 610 for the first month because it represents an outlier. In a third example, rental data set 610 may include utilities in a situation where landlord 24 charges cardholder 22 for rent and utilities. Pricing computer system 112 may accordingly average the rent in rental data set 610 to flatten the data. In a fourth example, rental data set 610 may indicate a change in rent. For example, twelve successive rental data sets 610 associated with cardholder 22 and landlord 24 may indicate payment in the amount of “$550.00” while the next three successive rental data sets 610 may indicate payment in the amount of “$575.00.” In the example embodiment, pricing computer system 112 is configured to wait for a predetermined amount of intervals before determining that a rental price has changed. In the example embodiment, pricing computer system 112 waits for three months before confirming a rental price change. In other embodiments, pricing computer system 112 may wait for shorter or longer intervals, or another prescribed time period, or receive user or external input to confirm a rental price change.

As described above, over a period of time, pricing computer system 112 may receive a plurality of rental data sets 610 related to cardholder 22 renting real estate 605. Accordingly, the plurality of rental data sets 610 may include data reflecting the history of the tenancy of cardholder 22 with real estate 605. Such history may indicate trends including, for example, move-in dates, move-out dates, and rental increases. In the example embodiment, pricing computer system 112 stores rental data sets 610 without including any protected personal information, which may otherwise be known as personally identifiable information (PII). Personally identifiable information is information that can be used on its own or with other information to identify, contact, or locate a single person, or to identify an individual in context. Accordingly, information which can identify cardholder 22 is not stored at pricing computer system 112. In alternative embodiments, personally identifiable information may be otherwise safeguarded by the policies of systems using rental data sets 610. In such alternative embodiments, personally identifiable information may be available to assist in determining additional information regarding real estate 605.

Pricing computer system 112 also receives rental listing data 620. Rental listing data 620 represents advertised listing prices for rent or purchase of real estate properties such as real estate 605. Rental listing data 620 may be stored in a database accessible to pricing computer system 112, retrieved from an external service or database, retrieved from online or offline publications, or manually entered into pricing computer system 112. In one example rental listing data 620 may be matched to rental data set 610 based upon geographic region 612. In other words, rental listing data 620 for a specific geographic region 612 is matched to rental data set 610 corresponding to the same geographic region 612. In other examples, rental data set 610 also includes real estate identifier 616. Real estate identifier 616 may include, for example, a street address, a geographic coordinate identifier, and an alphanumeric listing which identifies a property within a real estate service including, for example, a multiple listing service (“MLS”). Accordingly, using real estate identifier 616, real estate data set 610 may be more precisely matched to rental listing data 620.

Pricing computer system 112 may additionally receive real estate inventory data 630. Real estate inventory data 630 represents information related to real estate such as real estate 605 which may be used to determine a financial assessment, as discussed below. Real estate inventory data 630 may include, for example and without limitation, property tax associated with real estate 605, square footage associated with real estate 605, physical layout associated with real estate 605, a number of units rented/available associated with real estate 605, and service and maintenance records associated with real estate 605. While rental data sets 610 may be significantly helpful to determine cash flow associated with real estate 605, underlying conditions including maintenance and tax fees may change the profitability and value of real estate 605. Real estate inventory data 630 may be stored in a database accessible to pricing computer system 112, retrieved from an external service or database, retrieved from online or offline publications, or manually entered into pricing computer system 112.

Real estate data set 610 additionally includes real estate category 618. Real estate category 618 identifies real estate 605 within a type of real estate including, for example and without limitation, apartments, single family houses, multi-family houses, duplexes, and quadplexes. Real estate category 618 is an additionally beneficial component in determining a financial assessment for real estate 605. Certain categories of real estate 605 have different financial models than other categories. In some examples, real estate data set 610, rental listing data 620, and real estate inventory data 630 are processed to determine a valuation of real estate 605. In such examples, pricing computer system 112 stores the present valuation of real estate 605 with real estate data set 610.

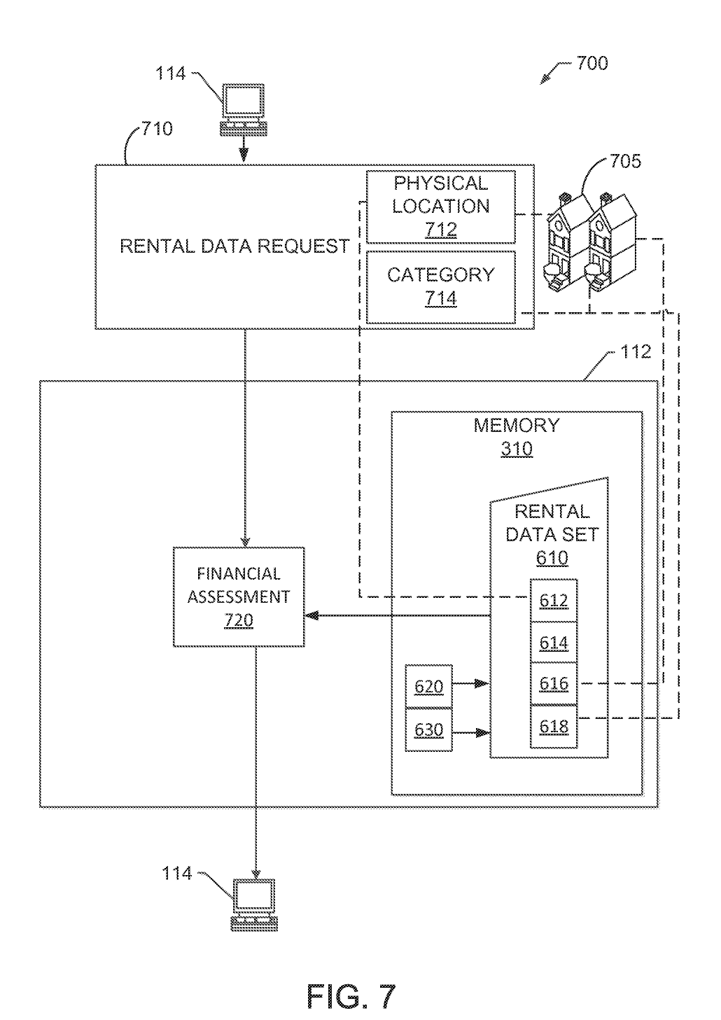

FIG. 7 is a simplified block diagram of an example embodiment of a system 700 for generating and transmitting a financial assessment 720 to a requestor 114 in response to a rental data request 710. As illustrated in FIG. 6, pricing computer system 112 stores a plurality of rental data sets 610 and associated data including rental listing data 620 and real estate inventory data 630 at memory 310. In alternative embodiments, rental data sets 610 and associated data may be stored in any appropriate device in communication with pricing computer system 112. Rental data sets 610 may include historical information regarding the rental of real estate and be associated with or contain rental listing data 620 and real estate inventory data 630.

A requestor using client system 114 creates a rental data request 710 to request information regarding a real estate asset 705 having a physical location 712. Client system 114 is in communication with pricing computer system 112 and pricing computer system 112 accordingly receives rental data request 710. Pricing computer system 112 processes rental data request 710 to determine a geographic region 612 containing physical location 712. Pricing computer system 112 retrieves rental data set 610 associated with geographic region 612. In some examples, pricing computer system 112 further retrieves only rental data set 610 associated with a particular category 714 to which real estate asset 705 belongs. More specifically, in some examples pricing computer system 112 retrieves rental data set 610 associated with geographic region 612 and category 714. In further examples, pricing computer system 112 retrieves only rental data set 610 associated with real estate asset 705. Pricing computer system 112 may retrieve only data set 610 by only retrieving data set 610 where real estate identifier 616 corresponds to real estate asset 705.

Pricing computer system 112 processes rental data set 610 and associated data including rental listing data 620 and real estate inventory data 630, if any. Pricing computer system 112 further generates a financial assessment 720. Generating financial assessment 720 represents generating at least one of a projected rental listing price for real estate asset 705, a projected rental listing price for real estate asset 705, a projected rental sales price for real estate asset 705, a projected cash flow for real estate asset 705, a projected value for real estate asset 705, and a variance between the projected rental listing price and the projected rental sales price for real estate asset 705. Financial assessment 720 may be generated by applying algorithms and methods to rental data set 610, rental listing data 620, and real estate inventory data 630. As a more precise rental data set 610 is obtained, a more precise financial assessment 720 may be generated. In other words, as rental data set 610 used to generate financial assessment 720 is constrained by geographic region 612, category 618, and real estate identifier 616, financial assessment 720 is more precise. Similarly, as more data including rental listing data 620 and real estate inventory data 630 is included, financial assessment 720 becomes more precise.

In the example embodiment, a projected rental listing price for real estate asset 705 may be determined by comparing rental listing data 620 to actual rental data reflected in rental data set 610. Depending on market conditions, even if the prevailing actual rental data reflected in rental data set 610 is at a first value of “$100.00” per month, pricing computer system 112 may project a projected rental listing price of “$125.00” per month to adjust for costs including, for example, negotiations and broker fees. A projected rental sales price for a real estate asset 705 may be obtained by analysis of rental data set 610 for geographic region 612, or real estate asset 705, specifically. A variance between the project rental listing price and the projected rental sales price for real estate asset 705 may be generated by comparing the projections.

A projected cash flow for a real estate asset 705 may be obtained by analysis of rental data set 610 considering historic data including, for example, latency between tenants. A projected value for real estate asset 705 may be obtained a discounted cash flow analysis of rental data set 610, external costs such as maintenance and taxes indicated in real estate inventory data 630, real estate category 618, and geographic region 612. Particular categories 618 of real estate assets 705 may involve different multipliers to discounted cash flow to determine a value. Similarly, particular geographic regions 612 of real estate assets 705 may involve different multipliers to discounted cash flow to determine a value. Upon determining financial assessment 720, pricing computer system 112 transmits financial assessment 720 to client system 114. In the example embodiment, pricing computer system 112 transmits financial assessment 720 by email. In alternative embodiments, pricing computer system 112 may transmit financial assessment 720 to client system 114 by any method including, without limitation, web services, web publication, file transfer protocol, SMS, and any other method of network communication. Additionally, pricing computer system 112 may generate financial assessment 720 as a physical document which is received by a human user (not shown) and manually entered into client system 114.

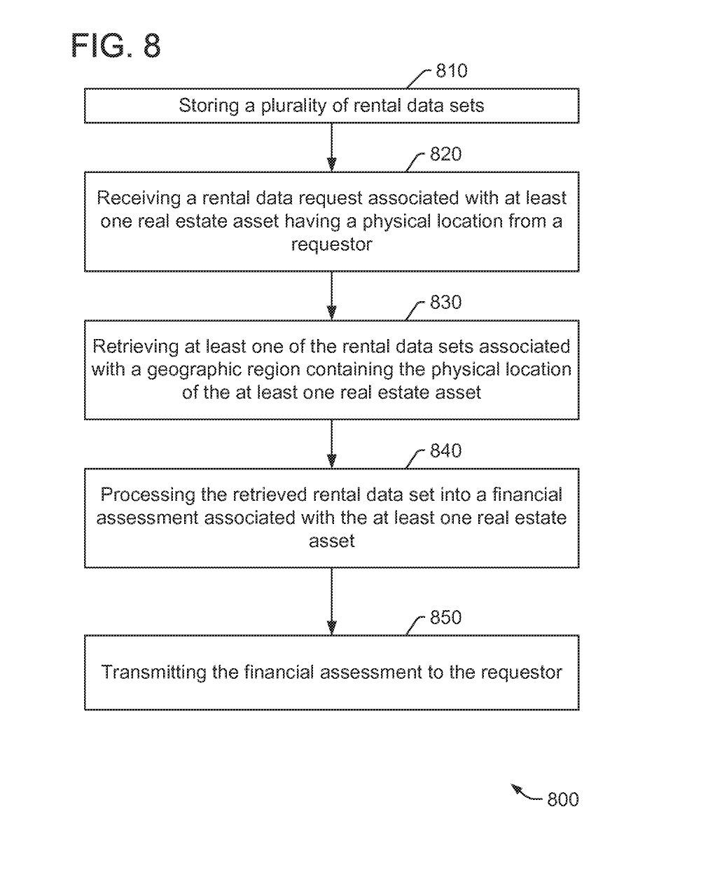

FIG. 8 is a simplified diagram of an example method of evaluating pricing of real estate using pricing computer system 112 (shown in FIG. 2). Pricing computer system 112 stores 810 a plurality of rental data sets. Storing 810 represents pricing computer system 112 receiving rental data sets 610 (shown in FIG. 6) from at least one of merchant 24, merchant bank 26, network 28, issuer bank 30 (all shown in FIG. 1). Storing 810 rental data sets 610 may further represent storing rental listing data 620 and real estate inventory data 630 (shown in FIG. 6). As described above, in the example embodiment storing 810 does not include storing personally identifiable information. In alternative embodiments, storing 810 includes storing personally identifiable information. In the example embodiment, storing 810 also includes storing rental data set 610 wherein rental data set 610 is associated with geographic region 612, real estate identifier 616, and real estate category 618 (all shown in FIG. 6). Further, storing 810 represents scanning rental data set 610 for the presence of rental transaction indicator 614 (shown in FIG. 6). Storing 810 also represents storing rental data including at least one of a geographic region, a rental price, a move-in date, a rental increase history, and a property categorization.

Pricing computer system 112 also receives 820 a rental data request associated with at least one real estate asset having a physical location from a requestor. Receiving 820 represents pricing computer system 112 receiving a rental data request 710 (shown in FIG. 7) from a computer device such as client system 114 (shown in FIG. 2) where rental data request 710 is associated with at least one real estate asset 705 (shown in FIG. 7) having a physical location 712 (shown in FIG. 7).

Pricing computer system 112 further retrieves 830 at least one of the rental data sets associated with a geographic region containing the physical location of the at least one real estate asset. Retrieving 830 represents pricing computer system 112 retrieving rental data set 610. Pricing computer system 112 may retrieve 830 rental data set 610 from memory 310 (shown in FIG. 5), storage device 134 (shown in FIG. 5), database 120 (shown in FIG. 2), or an external database or data storage (not shown). Pricing computer system 112 retrieves 830 rental data set 610 where rental data set 610 is associated with a geographic region 612 (shown in FIG. 6) containing physical location 712.

Pricing computer system 112 additionally processes 840 rental data set 610 into a financial assessment associated with the at least one real estate asset. Processing 840 represents generating financial assessment 720 wherein financial assessment is at least one of represents generating at least one of a projected rental listing price for real estate asset 705 (shown in FIG. 7), a projected rental listing price for real estate asset 705, a projected rental sales price for real estate asset 705, a projected cash flow for real estate asset 705, a projected value for real estate asset 705, and a variance between the projected rental listing price and the projected rental sales price for real estate asset 705.

Pricing computer system 112 also transmits 850 financial assessment to requestor. Transmitting 850 represents sending financial assessment 720 to a requestor such as client system 114. Alternately, pricing computer system 112 may transmit 850 financial assessment 720 to any requestor using any appropriate transfer protocol.

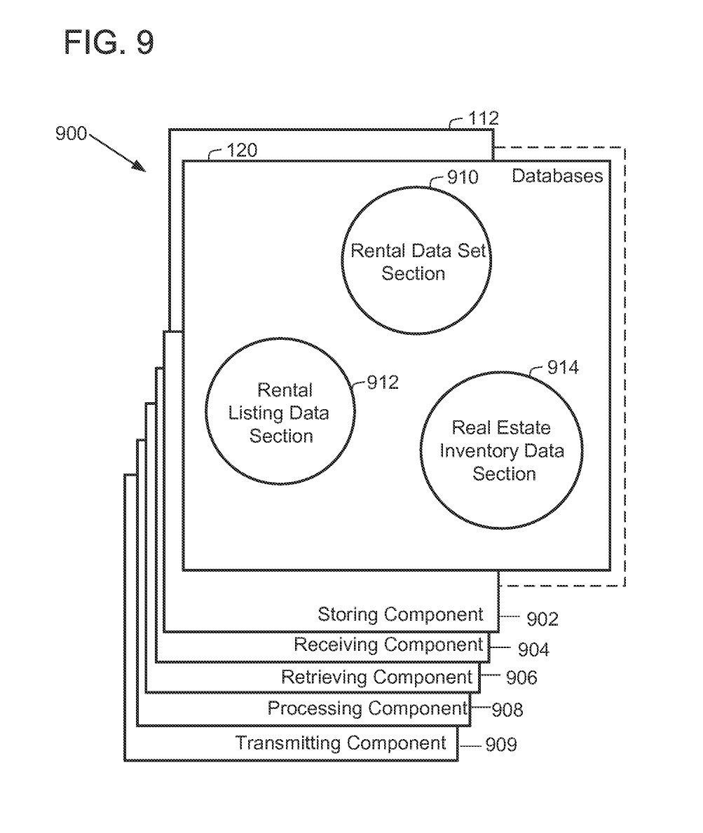

FIG. 9 is a diagram 900 of components of one or more example computing devices that may be used in the environment shown in FIGS. 6 and 7. FIG. 9 further shows a configuration of databases including at least database 120 (shown in FIG. 1). Database 120 is coupled to several separate components within pricing computer system 112, which perform specific tasks.

Pricing computer system 112 includes a storing 902 for storing a plurality of rental data sets 610 (shown in FIG. 6). Pricing computer system 112 also includes a receiving component 904 for receiving a rental data request 710 (shown in FIG. 7). Pricing computer system 112 additionally includes a retrieving component 908 for retrieving rental data sets 610. Retrieving component 908 also facilitates retrieving rental listing data 620 and real estate inventory data 630 (shown in FIG. 6). Pricing computer system 112 additionally includes a processing component 908 for processing the rental data sets 610, rental listing data 620 and real estate inventory data 630 into a financial assessment 720 (shown in FIG. 7). Pricing computer system 112 further includes a transmitting component 909 for transmitting financial assessment 720 to a requestor.

In an exemplary embodiment, database 120 is divided into a plurality of sections, including but not limited to, a rental data set section 910, a rental listing data section 912, and a real estate inventory data section 914. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for evaluating pricing of real estate, the method implemented by a computing device in communication with a memory, the method comprising:
storing, within the memory, a plurality of rental data sets, wherein each rental data set is associated with a geographic region and wherein each rental data set includes actual rental payment amounts made by tenants using a payment card;
receiving, at the computing device, a rental data request associated with at least one real estate asset having a physical location, from a requestor;
retrieving, from the memory, at least one of the rental data sets associated with a geographic region containing the physical location of the at least one real estate asset;
processing, by the computing device, the retrieved rental data set into a financial assessment associated with the at least one real estate asset; and
transmitting the financial assessment to the requestor.

2. The method of claim 1, wherein storing the plurality of rental data sets further comprises:
receiving transaction data associated with a financial transaction from a payment system;
determining that the transaction data is associated with a rental transaction based upon the presence of a rental transaction indicator; and
processing the transaction data into rental data, wherein rental data includes at least one of a geographic region, a rental price, a move-in date, a rental increase history, and a property categorization.

3. The method of claim 2 wherein determining that the transaction data is associated with a rental transaction based upon the presence of a rental transaction indicator further comprises:
scanning the transaction data for the presence of at least one rental transaction indicator, wherein the at least one rental transaction indicator includes at least one of:
a rental payee;
a payment period indicating a rental payment;
numerical characteristics of a rental payment; and
a repeated pattern of payment.

4. The method of claim 1, further comprising:
receiving, at the computing device, a plurality of rental listing data associated with a geographic region; and
storing the plurality of rental listing data.

5. The method of claim 1, wherein the rental data request and the plurality of rental data sets are further associated with a category of real estate.

6. The method of claim 1, wherein the memory stores the plurality of rental data sets without including personally identifiable information.

7. The method of claim 1, wherein the financial assessment includes at least one of:
a projected rental listing price for the real estate asset;
a projected rental sales price for the real estate asset;
a projected cash flow for the real estate asset;
a projected value for the real estate asset; and
a variance between the projected rental listing price and the projected rental sales price for the real estate asset.

8. The method of claim 1, further comprising:
determining from the plurality of rental data, a plurality of real estate assets;
determining from the plurality of real estate assets, a plurality of identifiers associated with the plurality of real estate assets;
retrieving real estate inventory data associated with each of the plurality of identifiers associated with the plurality of real estate assets; and
storing the real estate inventory data.

9. The method of claim 8, further comprising:
determining, using the rental data and the real estate inventory data, at least one economic value associated with each of the plurality of real estate assets.

10. The method of claim 8, wherein the real estate inventory data includes at least one of:
property tax data associated with the real estate asset;
square footage associated with the real estate asset;
a physical layout associated with the real estate asset; and
historical maintenance records associated with the real estate asset.

11. A pricing computer system for evaluating pricing of real estate comprising:
a processor;
a memory coupled to said processor, said processor configured to:
store, within said memory, a plurality of rental data sets, wherein each rental data set is associated with a geographic region and wherein each rental data set includes actual rental payment amounts made by tenants using a payment card;
receive a rental data request associated with at least one real estate asset having a physical location, from a requestor;
retrieve from the memory at least one of the rental data sets associated with a geographic region containing the physical location of the at least one real estate asset;
process the retrieved rental data set into a financial assessment associated with the at least one real estate asset; and
transmit the financial assessment to the requestor.

12. A pricing computer system in accordance with claim 11 wherein the processor is further configured to:
receive transaction data associated with a financial transaction from a payment system;
determine that the transaction data is associated with a rental transaction based upon the presence of a rental transaction indicator; and
process the transaction data into rental data, wherein rental data includes at least one of a geographic region, a rental price, a move-in date, a rental increase history, and a property categorization.

13. A pricing computer system in accordance with claim 12 further configured to:
scan the transaction data for the presence of at least one rental transaction indicator, wherein the at least one rental transaction indicator includes at least one of:
a rental payee;
a payment period indicating a rental payment;
numerical characteristics of a rental payment; and
a repeated pattern of payment.

14. A pricing computer system in accordance with claim 11 further configured to:
receive, at the computing device, a plurality of rental listing data associated with a geographic region; and
store the plurality of rental listing data.

15. A pricing computer system in accordance with claim 11 further configured to:
store the plurality of rental data sets, wherein each rental data set is further associated with a first category of real estate; and
receive the rental data request, wherein each rental data request is further associated with a second category of real estate.

16. A pricing computer system in accordance with claim 11, further configured to store the plurality of rental data sets without including personally identifiable information in the memory.

17. A pricing computer system in accordance with claim 11, wherein the financial assessment includes at least one of:
a projected rental listing price for the real estate asset;
a projected rental sales price for the real estate asset;
a projected cash flow for the real estate asset;
a projected value for the real estate asset; and
a variance between the projected rental listing price and the projected rental sales price for the real estate asset.

18. A pricing computer system in accordance with claim 11, further configured to:
determine from the plurality of rental data a plurality of real estate assets;
determine from the plurality of real estate assets, a plurality of identifiers associated with the plurality of real estate assets;
retrieve real estate inventory data associated with each of the plurality of identifiers associated with the plurality of real estate assets; and
store the real estate inventory data.

19. A pricing computer system in accordance with claim 18, further configured to:
determine, using the rental data and the real estate inventory data, at least one economic value associated with each of the plurality of real estate assets.

20. Computer-readable storage media for evaluating pricing of real estate having computer-executable instructions embodied thereon, wherein, when executed by at least one processor, the computer-executable instructions cause the processor to:
store a plurality of rental data sets, wherein each rental data set is associated with a geographic region and wherein each rental data set includes actual rental payment amounts made by tenants using a payment card;
receive a rental data request associated with at least one real estate asset having a physical location, from a requestor;
retrieve at least one of the rental data sets associated with a geographic region containing the physical location of the at least one real estate asset;
process the retrieved rental data set into a financial assessment associated with the at least one real estate asset; and
transmit the financial assessment to the requestor.
